(19) United States
(12) Patent Application Publication
(10) Pub. No.: US 2013/0183117 A1
(43) Pub. Date: Jul. 18, 2013

(54) BOLT RETENTION CLIP

(71) Applicant: Peter John Warburton, Gloucestershire (GB)

(72) Inventor: Peter John Warburton, Gloucestershire (GB)

(73) Assignee: ROLLS-ROYCE PLC, London (GB)

(21) Appl. No.: 13/876,991

(22) PCT Filed: Aug. 24, 2011
(86) PCT No.: PCT/EP11/64515

§ 371 Date: Mar. 29, 2013

(30) Foreign Application Priority Data
Oct. 14, 2010 (GB) 1017308.6

(51) Int. Cl. F16B 39/10; F16B 41/00

(52) U.S. Cl. CPC F16B 39/10; F16B 41/002
USPC 411/119

(57) ABSTRACT

This invention relates to a bolt retention clip, comprising: a base plate having a seat portion for the bolt head; first and second arms extending from opposing sides of the base plate so as define a bolt head zone in which the bolt head sits in use; and, an axis which is coaxial with the longitudinal axis of the bolt when in use, wherein the first and second arms each have a resilient outwardly curving portion, and a contacting surface in series with the outwardly curving portion for contacting the side of the bolt head in use.

This invention relates to a bolt retention device. In particular, this invention relates to a bolt retention clip for use where the head of the bolt is concealed when the bolt is tightened.

When assembling components into structures it is sometimes necessary to have bolted joints that are blind, i.e. the head of the bolt is concealed during assembly and bolting. In this case, the bolt must be restrained in some way to prevent axial and rotational movement. It is known to use bolt retaining clips to this end.

Known retaining clips for use in a gas turbine engine include those described in U.S. Pat. No. 4,887,949. However, the clips disclosed in U.S. '949 are prone to vibration induced failure which can lead to difficulties when the engine needs to be disassembled, for example, for maintenance purposes.

The present invention seeks to overcome problems with the bolt retention clips of the prior art.

In a first aspect, the present invention provides a bolt retention clip, comprising: a base plate having a seat portion for the bolt head; first and second arms extending from opposing sides of the base plate so as define a bolt head zone in which the bolt head sits in use; and, an axis which is coaxial with the longitudinal axis of the bolt when in use, wherein the first and second arms each have a resilient outwardly curving portion, and a contacting surface in series with the outwardly curving portion for contacting the side of the bolt head in use.

Having a resilient outwardly curving portions in the first and second arms allows the side of the bolt head to be positively gripped between the contacting surfaces. This stresses the arms and raises their resonant frequency accordingly. Altering the geometry and material of the arms allows the resonant frequency to be controlled which is advantageous for frequency sensitive applications, such as in a gas turbine engine.

The bolt retention clip may further comprise an inwardly curving portion in series with the outwardly curving portion, wherein the contacting surface is part of the inwardly curving portion.

The contacting portion may be an end or end portion of the outwardly curving portion. Preferably, the contacting surface may comprise a flat on the inwardly curving portion.

The outwardly curving potions may be concave with respect to the axis. The outwardly curving portions may extend through an angle in the range of between 90 degrees and 180 degrees. The outwardly curving portion may be include one or more straight portions which are connected to provide a generally curved profile. The curvature of the outwardly curving portion may have a plurality of radii.

The inwardly curving potions may be concave with respect to the axis. The inwardly curving portions may extend through an angle in the range of between 75 degrees and 150 degrees. The inwardly curving portion may include one or more straight portions which are connected to provide a generally curved profile. The curvature of the inwardly curving portion may have a plurality of radii.

The first and second arms may be connected directly to the base plate. Alternatively, the first and second arms may be connected to the base plate via an intermediate member. The first and second arms may be integrally formed with the base plate.

The resilient outwardly curving portions may bias the respective arms inwardly towards each other. It will be understood that the bias may also be provided by other portions of the first and second arms also.

At least one of the first and second arms may comprise an axial retention member to prevent the bolt being withdrawn from the bolt head zone along the axis. The axial retention member may include at least one barb placed on the respective outwardly extending portion. The barbs may form a funnel shape in combination for axially receiving a bolt head.

Distal ends of the first and second arms may include symmetrically opposing outwardly extending portions. The outwardly extending portions may in combination provide a funnel shape for receiving a bolt head along the axis.

The first and second arms may comprise a sheet material. The barbs may be an integral formation in the sheet material. The barbs may form part of the funnel shape.

The bolt retention clip may comprise an attachment formation for attaching the bolt retention device to a member which is to be bolted. The attachment formation may be a clip. The clip may be a “U” shaped clip dimensioned to receive a flange.

The bolt retention clip may comprise a third arm adjacent to and defining the bolt head zone along one edge. The third arm may be fenestrated. The fenestration may be in the form of one or more apertures towards a central portion of the third arm. Having a fenestrated third arm can be beneficial for weight saving purposes. The bolt retention clip may include a plurality of third arms which in combination define the bolt head zone.

The contacting surfaces may be flat. The contacting surfaces may extend the width of the clip.

The outwardly curving portions may be concave with respect to the bolt head zone.

In a second aspect, the present invention provides an assembly including the bolt retention clip of the first aspect.

In a third aspect, the present invention provides a gas turbine engine including the bolt retention clip of the first aspect.

The assembly may form part of a rotor in a gas turbine engine. One component of the assembly may be a rotor disc. Another component of the assembly may be a rotor stage drive arm.

An embodiment of the invention will now be described with the aid of the following drawings in which:

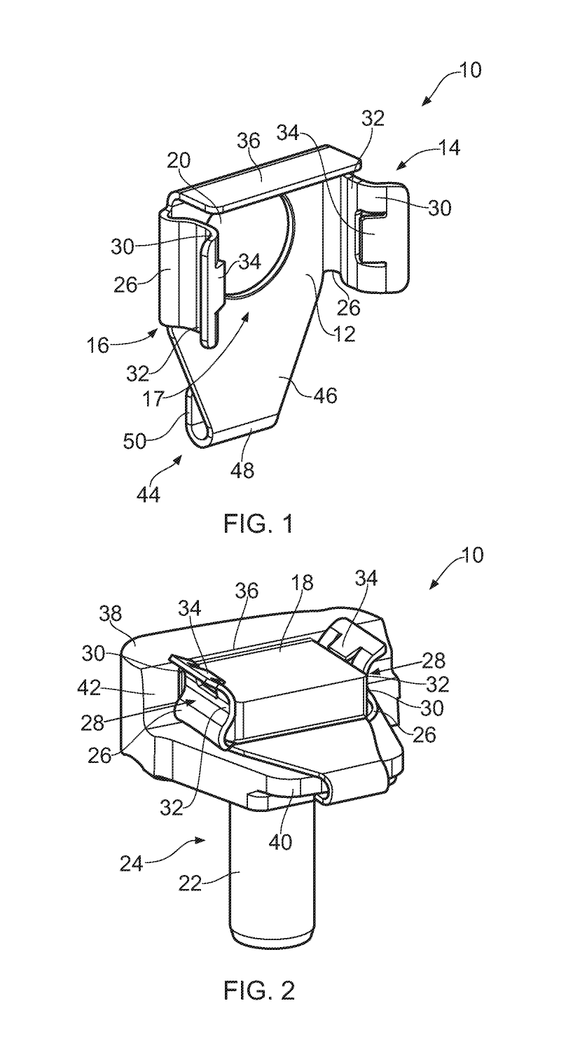

FIG. 1 shows perspective of a bolt retaining clip according to the present invention.

FIG. 2 shows the bolt retaining clip of FIG. 1 mounted on part of an assembly.

FIGS. 1 and 2 show a bolt retaining clip 10 which includes a base plate 12, a first arm 14 and a second arm 16. The first 14 and second 16 arms are connected to and extend from opposite sides of the base plate 12 to define a zone 17 in which the bolt head 18 is located and retained in use.

The base plate 12 is a flat rectangular plate having an aperture 20 at its centre for receiving the shank 22 of a bolt 24. The portions of the base plate 12 which surround the aperture 20 provide a seat for the underside of the bolt head 18 when in use.

The first 14 and second 16 arms extend generally perpendicularly from the short sides of the rectangular base plate 12 so as to symmetrically oppose each other. Each of the first 14 and second 16 arms includes a resilient outwardly curving portion 26 which curves outwardly with respect to the bolt head zone 17 and biases the first 14 and second 16 arms inwardly towards each other (as shown by arrows 28 in FIG. 2). The distal end of the outwardly curving portion adjoins an inwardly curving portion 30 such that the first 14 and second 16 arms are mirror images of an approximate “S” shape in cross section. The apex 32 of the inwardly curving portion 30 is flattened to provide a contacting portion for contacting with the side of the bolt head 18 in use. The arrangement of the outwardly curving and inwardly curving portions with the contacting portions results in the side of the bolt head being squeezed in use.

One particularly suitable application for the bolt retaining clip 10 of the present invention is in a gas turbine engine. It is well known that gas turbine engines have a number of engine order forcing frequencies which can severely weaken and fatigue any components with corresponding resonant frequencies. The applicants have found that some known clips suffer from arms with low resonant frequencies which can be excited by the engine during use. This can lead to failure of the clips with damaging consequences for the engine and difficulties when the bolts need to be removed during a maintenance strip down.

The present invention provides first 14 and second 16 arms with the resilient outwardly curving portions 26 so as to provide a compressive gripping force on the side of the bolt head 18. The gripping force increases the stress within the arms 14 16 and, consequently, their resonant frequency. Having an outwardly curving portion 26 in series with an inwardly curving portion 28 provides a space between the respective arms 14 16 and bolt head 18 which allows a sufficient amount of pressure to be exerted on the side of the bolt head 18. That is, if the arms 14 16 did not curve outwardly, and was straight for example, there is a risk that the side of the bolt would prevent the resilient member biasing arms towards each other to allow the bolt head 18 to be gripped in the required manner. In other words, the outwardly curving portions 26 provide the arms 14 16 with a pincer like formation which can be freely inwardly biased towards the bolt head 18 without fouling on the side of the bolt head 18.

The skilled person will appreciate that the resulting resonant frequency of the first 14 and second 16 arms can be tuned by adjusting the type and thickness of the material used to make the clip 10 as well as the specific geometry.

Toward the distal ends of the first 14 and second 16 arms there are located barbs 34 for retaining the bolt 24 within the device. The symmetrically opposing barbs 34 are flat plate like projections which protrude from the respective inwardly curving portion 30 and extend toward the base plate at an angle of approximately 25 degrees with respect to the base plate 12. The underside of the barbs 34, which is closest to the base plate 12, defines the upper boundary of the bolt head zone 17.

The two barbs 34 form a funnel like shape in combination which is configured to receive the bolt head 18 axially. Hence, when the bolt head 18 is axially pushed against the upper surfaces of the barbs 34, the first 14 and second 16 arms are urged apart until the bolt head 18 is free to pass into the bolt head zone 17. Once the bolt head 18 has passed the barbs 34, the resilient bias provided by the outwardly curving portion 26 urges the first 14 and second 16 arms back towards each other such that the contacting surfaces 32 push against the sides of the bolt head 18, with the barbs 34 rest above.

One advantage of the barbs 34 of the described embodiment is that they can serve the dual purpose of providing the funnel shape for urging the first and second arms 14 16 apart and the axial retaining means. Further, the barbs 34 are formed from portions of the inwardly curving portions of the arms 14 16 simply by punching a flap of the required shape into the arms 14 16 and bending it out of the plane of the arm 14 16 to the required angle.

A further advantage of the barbs 34 is that the funnel shape is suitable for receiving a square bolt head 18.

A third arm 36 in the form of an elongate plate extends perpendicularly from a long edge of the base plate 12. The third arm 36 defines a boundary of the bolt head zone 17 and can provide an anti-rotation function or an anti-fretting function as described next. In either context, the skilled person will appreciate from the following description that the only the portion of the third arm that contacts the edge portions of the bolt head will be directly utilised. Thus, it may be possible in an alternative embodiment to have a fenestrated third arm whilst still fulfilling the role.

FIG. 2 shows a component 38 which is suitable for use with the invention. The component includes a flange 40 and a shoulder 42 against which the third arm 36 can be placed. In this configuration, the bolt head 18 abuts the shoulder 42 via the third arm 36 and rotation is prevented when a nut (not shown) is tightened. In this way, the third arm 36 simply acts to protect the assembly from fretting and swarf which may be damaging depending on the application.

In an alternative application, it may be desirable to have the bolt on an open flat surface without a shoulder or other integral means for preventing the rotation of the bolt head 18. In this case, the third arm 34 can be made thick enough to prevent rotation of the bolt head alone without support. In keeping with this, the skilled person will appreciate that placing the bolt hole next to a flange or shoulder in this way can be beneficial as it means the third arm can be made from thinner metal. Hence, in the case where the clip is made from a punched sheet metal, the entire device can be made from thinner metal which can help save cost and time in manufacturing the clips, and weight which can be significant in an aero gas turbine engine.

The bolt retaining clip 10 includes an attachment formation for mounting the clip 10 to a component of the assembly ready for use. In the present embodiment, the clip 10 is for use with a flange 40 which includes an aperture for receiving the bolt shank 22. Thus the attachment formation 44 is in the form of a “U” shaped clip which is sized to receive the flange 40. The “U” shaped clip is formed from a tapered projection 46 which extends from a side of the base plate 12 to which it is coplanar. The tapered projection 46 terminates in with a 180 degree “U” bend 48. The arms of the U shaped clip define an internal gap which can snugly receives the flange 44 of the first part of the assembly.

The bolt retaining clip 10 is made from a sheet material in the form of stainless steel. The construction of the device is such that a blank can be punched out of the sheet material and simply folded to provide the finished bolt retaining clip 10. The skilled person will appreciate the thickness of the material used will depend on the application, size of bolts to be used and the required resonant frequency of the arms 14 16.

In use, the “U” shaped attachment formation is pushed over the flange 40 with the apertures in the base plate 12 and flange 40 aligned and the third arm 36 pushed up against the shoulder 42. The threaded end and shank 22 of the bolt 24 is pushed through the aperture until the underside of the bolt head contacts the extremities of the first 14 and second 16 arms. Further pushing results in the underside of the bolt head 18 sliding down the upper surfaces of the barbs 34 and a splaying of the arms 14 16. This action continues until the gap between the barbs 34 is sufficient to let the bolt head 18 slot into the bolt head zone 17. Once past the barbs 34, the first 14 and second 16 arms snap back into position under the bias of the resilient outwardly curving portions 26. The resilient force of the outwardly curving portions 26 then provides a compressive force to the outside faces of the bolt head which results in the desired stress and increased resonant frequency.

Once in place, the rest of the components can be coupled together and assembled over the bolt as required. Thereafter a nut can be screwed onto the thread of the bolt and tightened without requiring access to the bolt head.

The skilled person will appreciate that the above embodiment is exemplary and not definitive.

For example, the skilled person will appreciate that the barbs included to prevent axial movement of the bolt are optional and that the axial movement may, in some embodiments, be limited by the compressive gripping force of the first and second arms alone.

1-16. (canceled)

17. A bolt retention clip, comprising:
a base plate having a seat portion for the bolt head;
first and second arms extending from opposing sides of the base plate so as define a bolt head zone in which the bolt head sits in use; and,
an axis which is coaxial with the longitudinal axis of the bolt when in use,
wherein the first and second arms each have a resilient outwardly curving portion, and a contacting surface in series with the outwardly curving portion for contacting the side of the bolt head,
the resilient outwardly curving portion being arranged to exert a gripping force on the side of the bolt head when in use.

18. A bolt retention clip as claimed in claim 17 further comprising an inwardly curving portion in series with the outwardly curving portion, wherein the contacting surface is part of the inwardly curving portion.

19. A bolt retention clip as claimed in claim 17, wherein the contacting surface comprises a flat on the inwardly curving portion.

20. A bolt retention clip as claimed in claim 17 wherein the resilient outwardly curving portion biases the respective arms inwardly towards each other.

21. A bolt retention clip as claimed in claim 17, wherein at least one of the first and second arms comprises an axial retention member to prevent the bolt being withdrawn from the bolt head zone along the axis.

22. A bolt retention clip as claimed in claim 17, wherein distal ends of the first and second arms include symmetrically opposing outwardly extending portions which in combination provide a funnel shape for receiving the bolt head along the axis.

23. A bolt retention clip as claimed in claim 17 wherein the axial retention member includes at least one barb placed on the respective outwardly extending portion so as to form part of the funnel shape.

24. A bolt retention clip as claimed in claim 23, wherein the first and second arms comprise a sheet material, wherein the barb is an integral formation of the sheet material.

25. A bolt retention clip as claimed in claim 17 further comprising an attachment formation for attaching the bolt retention device to a member which is to be bolted.

26. A bolt retention clip as claimed in claim 25 wherein the attachment formation is a clip.

27. A bolt retention clip as claimed in claim 17 further comprising a third arm adjacent to and defining the bolt head zone.

28. A bolt retention clip as claimed in claim 27 wherein the third arm is fenestrated.

29. A bolt retention clip as claimed in claim 17 wherein the contacting surfaces are flat.

30. A bolt retention clip as claimed in claim 17 wherein the outwardly curving portions are concave with respect to the bolt head zone.

31. A gas turbine engine comprising a bolt retention clip as claimed in claim 17.
